(19) United States
(12) Patent Application Publication
(10) Pub. No.: US 2025/0077214 A1
(43) Pub. Date: Mar. 6, 2025

(54) SERVERLESS CONTAINERIZATION OF COLLABORATION APPLICATIONS FOR AUTOMATIC INSTALLATION AND VERSION UPDATES

(71) Applicant: MASTERCARD TECHNOLOGIES CANADA ULC, Vancouver (CA)

(72) Inventor: Nikhil BANAAL, Surrey (CA)

(73) Assignee: MASTERCARD TECHNOLOGIES CANADA ULC, Vancouver (CA)

(21) Appl. No.: 18/457,516

(22) Filed: Aug. 29, 2023

(51) Int. Cl. G06F 8/65; G06F 8/71; H04L 9/40

(52) U.S. Cl. CPC G06F 8/65; G06F 8/71; H04L 63/0272; H04L 63/104

(57) ABSTRACT

Serverless containerization of a collaboration application improves deployment and security of the collaboration application. A system may generate a container within a private cloud. The container may execute the collaboration application. The container is assigned an Internet Protocol (IP) address and is associated with a security group that controls network traffic to and from the container. The system may include a network load balancer configured with the IP address assigned to the container that allocates computational resources for executing the collaboration application. The system may include serverless resources such as a database and filesystem that is accessible to the container within the private cloud. The system may include a private cloud (PC) endpoint configured to establish a private connection with an end user interface, wherein the private connection provides secure network traffic between the PC endpoint the end user interface within a private network of the PC endpoint.

### BACKGROUND

Deploying an application involves ensuring that underlying systems have necessary installation requirements and are compatible with the application. For example, in order to properly execute, the application may have various dependencies that must be included in the runtime environment. Thus, deploying an application may be a time-consuming and error-prone process. Once deployed, the application may be revised for bug fixes, upgrades, security patches, and other reasons. When the application is revised, a new version of the application is created. Systems that use the application may be required to download and install the new version. The new version may also require extensive installation procedures to ensure that the new version will operate as expected. For example, a new version may require a certain resource that a prior version did not. Installation errors and/or unexpected performance of the application may result after an initial deployment and/or subsequent deployments of the application. Furthermore, in some cases, a new version of the application may not work as expected because of bugs, incompatibilities between the new version and the runtime environment in which the application executes, improper configurations, and other reasons. In these instances, a prior version of the application may be required to restore functionality provided by the application. In some instances, zero day vulnerabilities of applications may also require shutting down a current version and redeploying a prior known good version or the current version. These redeployments may face the same issues as the original deployment. Thus, what is needed is an ability to seamlessly install desired versions of an application while minimizing errors.

### BRIEF DESCRIPTION OF THE DRAWINGS

Features of the present disclosure may be illustrated by way of example and not limited in the following figure(s), in which like numerals indicate like elements, in which:

FIG. 1 illustrates an example of a system environment for serverless execution of a containerized collaboration application;

FIG. 2 illustrates an example of an architecture to generate a container for serverless containerization of the collaboration application;

FIG. 3 illustrates an example of a method of configuring a private cloud for containerizing a collaboration application;

FIG. 4 illustrates an example of a method of sharing project data using a containerized collaboration application;

FIG. 5 illustrates an example of a method of a containerized collaboration application; and

FIG. 6 illustrates an example of a computer system that may be implemented by devices illustrated in FIGS. 1 and 2.

### DETAILED DESCRIPTION

The disclosure relates to methods and systems of serverless containerization of a collaboration application. The collaboration application is software code that provides functionality for knowledge sharing. The collaboration application may be used by end users to share project data and collaborate with one another. Serverless containerization is the execution of an application in a container without managing or provisioning servers. For example, the container may be generated by and execute on hardware that is provisioned automatically by a serverless computer system. In particular, the serverless computer system may provide a platform as a service in which hardware, such as servers having computer processors and memory, are used to generate a container in which the collaboration application executes. To facilitate automated deployment of different versions of the collaboration application, a container image of the collaboration application may be generated. A container image is a lightweight, standalone, executable package of software that includes components needed to run an application. The components may include, without limitation, the code for the collaboration application written in a programming language, the runtime environment, system tools, system libraries and settings.

The serverless computer system may generate a container based on the container image. For example, the serverless computer system may provision the container with the components needed to run the collaboration application. Thus, the container is a self-contained operating environment in which the collaboration application executes. The collaboration application configured to execute in the container will be referred to as a containerized collaboration application. Thus, the term “collaboration application in a container” and similar terms will be referred to interchangeably as a containerized collaboration application.

The containerized collaboration application may operate in a secure manner and be deployed automatically through the use of container images and serverless execution. The containerized collaboration application may provide knowledge sharing among users in a secure way that tolerates the need to redeploy the containerized collaboration application to respond to security threats, version updates, or other issues that may require clean installation of an existing version or change to a different version.

The serverless computer system may operate a secure computer network and generate a private cloud assigned with specific subnets within the private network specifically for the containerized collaboration application. Within the private cloud, the serverless computer system may generate the container and provide and execute serverless resources that may be used by the container based on a containerized application definition. The serverless resources may include a serverless database, an serverless filesystem, a load balancer, and/or other resources. The containerized application definition may include an identifier that identifies the container image, one or more serverless resources to be used by the container, settings for the container, and/or other information relating to containerizing the collaboration application.

The serverless computer system may configure the container and the serverless resources to be accessible to one another within the one or more subnets of the private cloud but not accessible from outside the private cloud, other than as specifically configured. For example, a private cloud endpoint may be configured to control network traffic to and from the private cloud and its associated container and serverless resources. In particular, the private cloud endpoint may control access through access Identity and Access Management (IAM) control techniques, which may include user authentication. In some examples, the private cloud endpoint may expose a Uniform Resource Locator (URL) that is accessed by browsers executing on user devices. End users may access the private cloud endpoint to transmit data to and receive data from the containerized collaboration application, such as via the URL. Thus, end users may collaboratively share data with one another through the containerized collaboration application, which is accessed through the virtual cloud endpoint.

In operation, end users may collaboratively share project data with one another via the containerized collaboration application. For example, end users may each logon to the containerized collaboration application via the private cloud endpoint. Requests to access project data in the virtual workspace may be made via a call to a Uniform Resource Locator (URL) of the private cloud endpoint, which controls HTTP traffic to the containerized collaboration application. More specifically, the HTTP traffic containing the requests may be routed by the from the private cloud endpoint to a load balancer, which distributes the traffic according to existing loads. The containerized collaboration application may access appropriate serverless resources to fulfill the request. For example, the containerized collaboration application may access the serverless database to write, read, delete, or modify data to fulfill the request. In another example, the containerized collaboration application may access the serverless filesystem to similarly write, read, delete, or modify data to fulfill the request. If data is to be returned in response to the request, the containerized collaboration application may provide that data back to the end user via the private cloud endpoint. It should be noted that multiple end users may concurrently or at separate times access the containerized collaboration application to collaboratively share project data. Collaboratively sharing project data is reading, writing, deleting, or modifying data that is managed via the containerized collaboration application in a way that is accessible to other end users.

At various times throughout this usage, different versions of the containerized collaboration application may replace the currently executing version in a seamless manner without extensive, manual deployment, which may reduce errors and improve the security of the containerized collaboration application and its data. For example, the serverless computer system may determine that a different version of the collaboration application is to be containerized to replace the currently executing containerized application. In particular, a developer may update the containerized application definition to point to a different application version than one that is currently executing in the container. This version can be a newer version or a previous version that the currently executing collaboration application. The serverless computer system may recognize the change (thereby determining that the different version is to be containerized), automatically access the appropriate container image corresponding to the different version, and re-generate the containers based on the appropriate container image. In this way, new or different versions of the collaboration application may be seamlessly deployed without installation errors that may otherwise occur with a version change.

In some examples, the serverless computer system may recover from non-performance of the collaboration application. For example, if the collaboration application throws an error or is unreachable, the serverless computer system may revert to a known good version of the containerized collaboration application, replacing the currently executing version. The known good version may be the same version (to essentially terminate and then restart a new container with the same version) or may be a different version. This may occur automatically (without human intervention that requests the replacement) when the collaboration application has errored or cannot be reached. The foregoing may address unexpected code bugs or security threats such as zero day vulnerabilities. In some other examples, a human such as a developer may order a stoppage to the containerized collaboration application.

Having described a high level overview of serverless containerization of a collaboration application, a system environment for doing so will now be described.

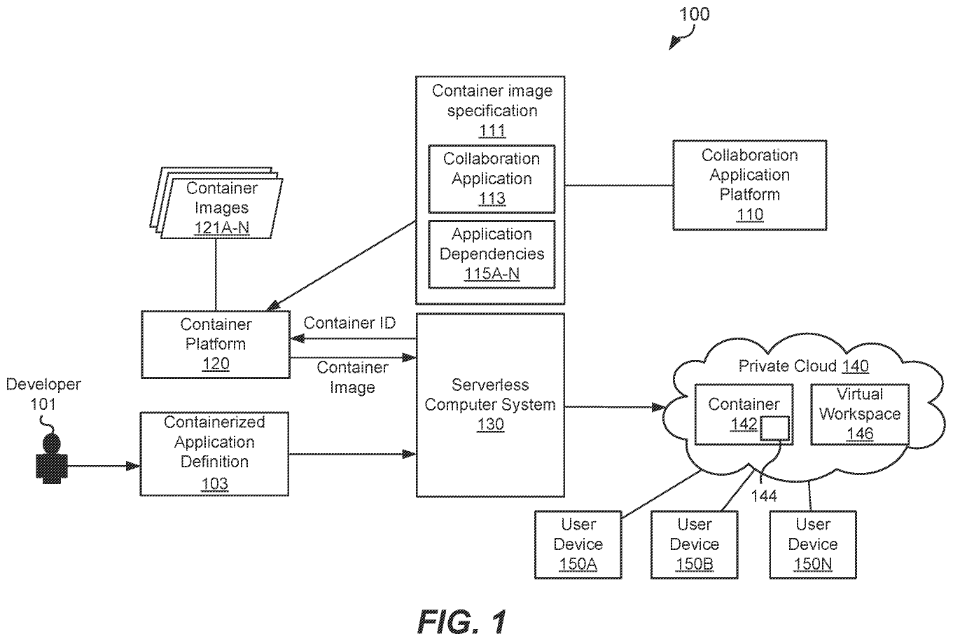

FIG. 1 illustrates an example of a system environment 100 for serverless execution of a collaboration application 113 within a container 142. The system environment 100 may include a collaboration application platform 110, a container platform 120, a serverless computer system 130, a plurality of user devices 150 (illustrated as user devices 150A-N), and/or other features.

The collaboration application platform 110 may provide a collaboration application 113 for end users to create, share, and organize project data via a virtual workspace 146. The virtual workspace 146 is a collection of project data that may be organized by individual teams of end users. Project data is content that the users may collaboratively share through the collaboration application 113. The project data may include documents, project information, software code, configuration data, and/or other data that can be viewed, modified, deleted, or inserted by multiple end users that share the virtual workspace 146. For example, a first user may edit project data or other content that is shared in the virtual workspace 146 and a second user may approve or provide further edits to the project data. The updated project data may be made available to other end users in the virtual workspace 146. The collaboration application 113 may specify security roles that restrict access to the data in the virtual workspace 146. Different permissions may be enabled based on the security role of a particular end user. For example, one user may have a security role that enables read and write permission on a document in the virtual workspace 146 while another user may have a more limited security role that enables only read permission on the document.

The collaboration application 113 may include an interface for interacting with project data. The interface may include a graphical user interface (GUI), a command line interface, and/or other types of interfaces. The GUI may be presented via a Uniform Resource Locator (URL) or other address that can be accessed by a user device 150, such as through a web browser. In these examples, each end user may collaboratively access the project data via their respective user devices 150. The collaboration application 113 is code that is written in a programming language that is compiled or interpreted by a computer for execution. The collaboration application 113 may require a plurality of application dependencies 115 (illustrated as application dependencies 115A-N) to execute. The application dependencies 115 may include a other code such as software libraries or applications, databases, and/or other computer components the collaboration application 113 may require for execution.

To facilitate containerization, the collaboration application platform 110 may generate a container image specification 111. The container image specification 111 may include the collaboration application 113 (such as the code for the collaboration application 113) and application dependencies 115A-N. The collaboration application platform 110 may transmit the container image specification 111 to the container platform 120.

The container platform 120 may generate a container image 121 based on the container image specification 111 transmitted by the collaboration application platform 110. A container image 121 is a lightweight, standalone, and executable software package that contains the components needed to run the collaboration application 113, including the application dependencies 115. The container image 121 may provide a consistent and reproducible environment for running the collaboration application 113 across different computing environments. Examples of a container platform 120 that can generate and store container images 121 include DOCKER, REDHAT OPENSHIFT, and JETTY, among others.

A developer 101 may generate a containerized application definition 103 for Atlassian confluence using AWS fargate service which is serverless computer system 130 to generate the container 142. The containerized application definition 103 is configuration data that defines one or more containers 142 to be used, settings of the containers, container interactions with one another, and/or other data for executing the containerized collaboration application 144, which executes in the container 142. As such, the containerized application definition 103 enables deployment of container-based workloads in a serverless architecture at scale in a serverless architecture of the serverless computer system 130.

The containerized application definition 103 may include an indication of network firewall security groups, version identifier that identifies a version of the collaboration application to use, identification of ports to use, mount path of storage, install directories, database required for back end storage, shared file, load balancer, endpoint for a private connection between an end user interface and the load balancer to control traffic within the private cloud 140 within the network of the serverless computer system 130, and/or other configuration data associated with the container. The containerized application definition 103 may further include a container definition, one or more access roles, network configurations, task constraints, disk volume configurations, and/or other configuration data used to configure or otherwise generate the container 142. A container definition may include the container image identifier, computational requirements such as CPU and memory requirements, environment variables, port mappings, volumes of disk to use, and other container-specific configurations.

The one or more access roles may include roles that enable the container to interact with other services or components of the serverless computer system 130, permission to obtain container images or publish log files, and/or other access control rules. The network configurations may specify how containers may access the network in different network modes such as bridge and host modes. The task constraints may include rules that define where the load balancing or other constraints such as where the container 142 should be placed within a cluster of servers of the serverless computer system 130 based on attributes such as instance type, availability zone, or custom metadata. The disk volume configurations define shared data volumes that can be mounted by the container 142, enabling data sharing across containers.

The developer 101 may provide a request to the serverless computer system 130 to generate the container 142. The request may include the containerized application definition 103. The request may also include a container image identifier that identifies the container image 121 or the container image identifier may be included in the containerized application definition 103. Responsive to the request, the serverless computer system 130 may obtain the container image 121 from the container platform 120 based on the container image identifier through one or more interfaces exposed by the container platform 120. These interfaces may include a command line interface (“CLI”) command that pulls the container image 121, a Uniform Resource Locator (URL) from which the container image 121 may be downloaded or otherwise obtained, and/or other interfaces. The serverless computer system 130 may generate a private cloud 140.

The serverless computer system 130 may perform serverless containerization of the collaboration application 113 based on a container image 121. For example, the serverless computer system 130 may allocate a private cloud 140 for the containerized collaboration application 144. A private cloud 140 is an isolated portion of a communication network on which the serverless computer system 130 operates. For example, the isolated portion may include one or more subnets within the communication network. Traffic to and from the private cloud 140 is controlled, making this portion of the communication network isolated from other portions. The serverless computer system 130 may generate a container 142 based on the container image 121 and data (other than the container image identifier) defined by the containerized application definition 103. The container 142 may be configured to operate within the private cloud 140. For example, the serverless computer system 130 may create the runtime environment based on the application dependencies 115 identified in the container image 121 to generate the container 142, which is then used to execute the collaboration application 113. The various interactions and other settings of the container 142 (such as interaction with other containers 142 if more than one container 142 is generated for the collaboration application 113) may be configured based on the containerized application definition 103.

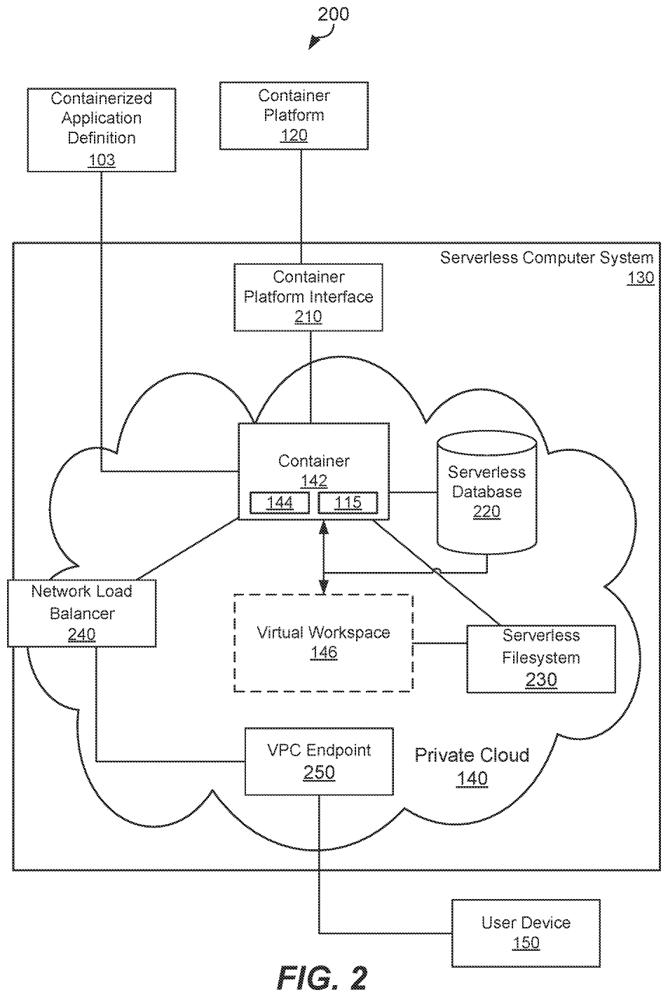

To illustrate configuration of the private cloud 140 and container 142, reference will be made to FIG. 2, which illustrates an example of an architecture 200 to generate the container 142 for serverless containerization of the collaboration application 113 within the serverless computer system 130. For example, the serverless computer system 130 may include a container platform interface 210 that pulls the container image 121 and generates the container 142, a serverless database 220, an serverless filesystem 230, a network load balancer 240, private cloud (PC) endpoint 250, and/or other features.

The container platform interface 210 is configured to obtain the container image 121 of the collaboration application 113 from the container platform 120 based on the container image identifier. The container platform interface 210 may generate the container 142 based on the container image 121 and the containerized application definition 103. The container 142 is assigned an Internet Protocol (IP) address and is associated with a security group to identify permitted (and/or non-permitted) network traffic to and from the container 142. Such network traffic may be between the container 142, other containers, the serverless database 220, the serverless filesystem 230, the network load balancer 240, the PC endpoint 250, and/or resources within the serverless computer system 130.

In some examples, the containerized application definition 103 may specifically allocate one or more serverless resources such as databases, filesystems, or secure communication systems for use by the container 142. The serverless computer system 130 may provide the container 142 with access to these serverless resources hosted within the serverless computer system 130.

For example, the container 142 may be provided with access to a serverless database 220 that is enabled with the security group of the container 142. As such, the container 142 may have access to the serverless database 220. The serverless database 220 may store project data for the collaboration application 113 executing within the container 142. The serverless database 220 may provide high performance, scalability, and durability. For example, the serverless database 220 may increase or decrease computational resources it uses based on usage. The serverless database 220 may support various types of database, including MYSQL, PostgreSQL, and/or others.

The serverless database 220 may deliver high performance with low latencies based on a distributed architecture that scales storage and computational resources independently, facilitating efficient execution of high workloads. The serverless database 220 may scale horizontally by automatically adding replicas to handle read traffic, providing increased read scalability. The serverless database 220 may provide automatic scaling of computational resources based on workload demands, which automatically adjusts capacity based on traffic loads to or from the collaboration application 113 executing in the container 142. The serverless database 220 may provide a highly available architecture with built-in redundancy with data replication, ensuring durability and fault tolerance. In the event of a primary instance failure, the serverless database 220 may automatically failover to a backup replica. For data replication, the serverless database 220 may use multiple storage nodes in a cluster.

The container 142 may be provided with an ability to mount the serverless filesystem 230, which is configured to receive an installation of the collaboration application 113 and to host a home directory used by the collaboration application 113 to save attachments executing within the container 142. For example, to facilitate access to the serverless filesystem 230, the container 142 may be configured to execute within the same private cloud as the serverless filesystem 230 such as by establishing one or more subnets of the virtual cloud and generating the container 142 and the serverless filesystem 230 within the same subnet. Furthermore, the serverless filesystem 230 may be enabled with (associated with) the same security group as the container 142 to allow inbound/outbound traffic on the network filesystem ports used by the serverless filesystem 230. The serverless filesystem 230 is a scalable file storage system that may be shared across multiple services provided by the serverless computer system 130 and containers 142, such as when they share the security group. The serverless filesystem 230 may then be mounted by mounting the target DNS name, file system ID, and the mount point directory within the file system of the container 142.

The serverless filesystem 230 may automatically scale its storage capacity as files are added or removed, permitting increase usage to a theoretical unlimited capacity (limited by the capacity of the serverless computer system 130 and its connected storage). The serverless filesystem 230 may permit concurrent access to files from multiple containers 142 and ultimate end users, permitting data sharing among the users of the collaboration application 113.

A PC endpoint 250 is a private network that connects private clouds on which the container 142 execute within the serverless computer system 130 to various services that the serverless computer system 130 provides without using a wider public network such as the public internet. The PC endpoint 250 may be configured to establish a private connection to service for an end user requests. The private connection provides secure network traffic between the PC endpoint and the end user interface within a private network of the PC endpoint. The end user interface may include a browser-based or other type of interface. In these examples, the PC endpoint 250 may be exposed via an address that is linked to a URL that can be used to collaborate with other end users based on the containerized collaboration application 144. For example, a browser of a user device 150 may use the URL to access the containerized collaboration application 144. The URL may resolve to the address of the PC endpoint 250.

The PC endpoint 250 may be securely connected to other services provided by the computer system 130 without using internet gateways, NAT (Network Address Translation) devices, VPN (Virtual Private Network) connections, or public IP addresses. This is because a PC endpoint 150 provides a direct and private connection between the PC and the supported services without using a wider public network such as the public internet. This also ensures enhanced security, lower latency, and reduced data transfer across public networks.

In some examples, each PC endpoint 250 may be subject to access control. For example, each PC endpoint 250 may be configured with a security policy that specifies traffic or users that may access the PC endpoint 250. PC endpoints 250 may use routing tables in the PC to determine how traffic is directed to the endpoints. Traffic may be managed via load balancing by the network load balancer 240.

The PC endpoint 250 may have a corresponding entry in a Domain Name System (DNS) table of the serverless computer system 130. The DNS entry may include fields that include a mapping between, for example, a domain name and an IP address. For example, end users may access the containerized collaboration application 144 via a domain name that maps to the IP address of the container 142 or other resource associated with the containerized collaboration application 144. In this way, requests from end users may be routed to the appropriate container 142.

A network load balancer 240 may be configured with the IP address assigned to the container 142 that allocates one or more computational resources for executing the collaboration application 113 based on respective computational loads of a pool of computational resources that are available to execute. For example, the container 142 may be allocated with computational resources required by the container 142 and according to the current load status of available computational resources. The computer resources may include processor speed, minimum memory, minimum disk space, and/or other computational attributes that are required to run the collaboration application 113. These requirements may be specified by the containerized application definition 103 and may be allocated to the container 142. In some examples, the container 142 may actually be multiple containers 142 that are generated for executing the collaboration application 113.

Load balancing is a technique used to distribute incoming network traffic across multiple containers 142 and other resources to improve application availability, fault tolerance, and scalability. Load balancing evenly distributes the workload to optimize performance. Different types of load balancing may be used. For example, elastic load balancing may distribute incoming application traffic across multiple availability zones through an application load balancer, a network load balancer, or a classic load balancer. The application load balancer operates at the application layer (Layer 7 of the Open Systems Interconnection (OSI) model) and may be used for HTTP. It supports advanced routing and content-based routing for sophisticated application architectures. The network load balancer operates at the transport layer (Layer 4) and is suitable for handling high volumes of TCP, UDP, and TLS traffic. The classic load balancer operates at both the application and transport layers and may be suitable for relatively simple applications.

In operation, the user device 150 may access the containerized collaboration application through the PC endpoint 250. The network traffic from the user device 150 and other traffic to, from, or within the private cloud 140 may be routed by the network load balancer 240. The containerized collaboration application executing in the container 142 may respond to requests from the user device 150. For example, the request may be to access project data. Depending on where the project data is stored, the containerized collaboration application may transmit requests to the serverless database 220 and/or the serverless filesystem 230.

The containerized collaboration application 144 may enable collaborative data sharing through the virtual workspace 146. The virtual workspace 146 may be used to read, write, delete, or modify the project data. The containerized collaboration application 144 may access the project data from the serverless database 220 and/or the serverless filesystem 230. For example, documents may be stored as documents on the serverless filesystem 230, in which case the containerized collaboration application 144 may access the documents from the serverless filesystem 230. Calendar data may be stored in the serverless database 220, in which case the containerized collaboration application 144 may access the calendar data from the serverless database 220. Other project data may be similarly accessed depending on the storage location.

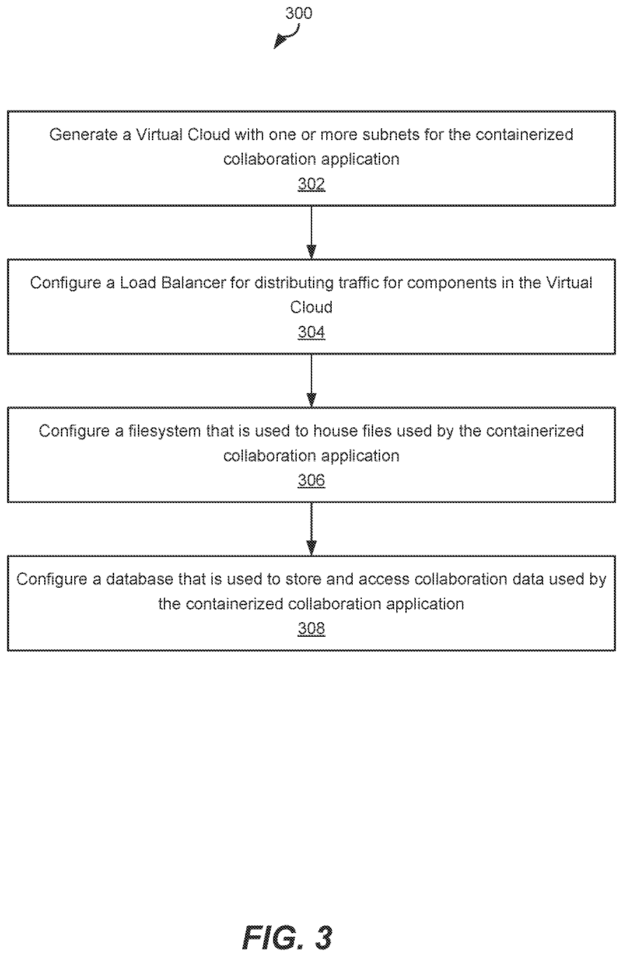

FIG. 3 illustrates an example of a method 300 of configuring a private cloud 140 for containerizing a collaboration application. At 302, the method 300 may include generating a virtual cloud (such as the private cloud 140). Within the virtual cloud, a container (such as the container 142) in which a containerized collaboration application (such as the containerized collaboration application 144) executes may be generated. At 304, the method 300 may include configuring a load balancer (such as the network load balancer 240) for distributing traffic for components in the virtual cloud. The load balancer may be configured with an IP address of the container 142.

At 306, the method 300 may include configuring a serverless filesystem (such as the serverless filesystem 230). Configuring the serverless filesystem may include mounting a filesystem provided by the serverless computer system 130 and generating one or more directories used by the containerized collaboration application. The serverless filesystem may be configured with the security group of the container so that the container may access files on the serverless filesystem. At 308, the method 300 may include configuring a serverless database (such as the serverless database 220). The serverless database 220 may be configured with one or more tables, including columns of the tables, used by the containerized collaboration application.

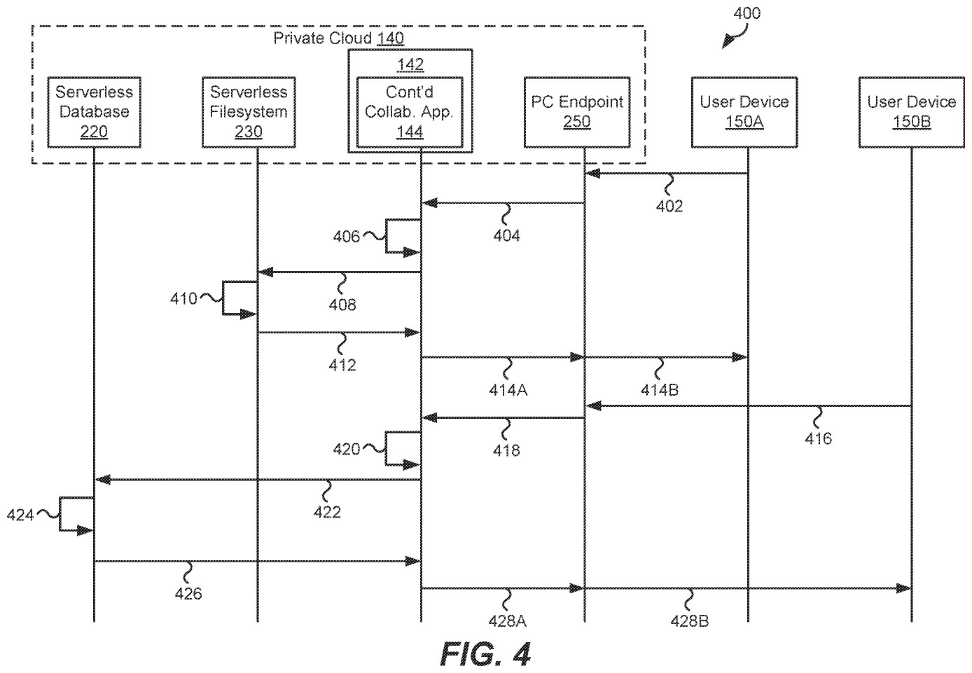

FIG. 4 illustrates an example of a flow diagram 400 of sharing project data using a containerized collaboration application 144. End users may use respective devices (such as user device 150A and 150B as illustrated) to access the containerized collaboration application 144 via the PC endpoint 250. For example, the PC endpoint 250 may be assigned with a Domain Name System (DNS) name. The DNS name may be a private name, in which case browsers of each user device 150 may be configured to access private DNS names. The DNS name of the PC endpoint 250 may be assigned with an IP address that is recognized and accessible to the components of the private cloud 140, such as the container 142 in which the containerized collaboration application 144 executes, the serverless database 220 and the serverless database 220. The containerized collaboration application 144 may provide a virtual workspace 146 (illustrated in FIGS. 1 and 2) through which end users may collaboratively share project data.

To collaboratively share (read, write, modify, delete, etc.) project data, each of the user devices 150 may establish a connection with the private cloud 140. For example, the user device 150A may access the PC endpoint 250 using the DNS name. The user device 150A may be operated by a first end user that enters the DNS name into a browser of the user device 150A. The first end user may collaboratively share project data with a second end user, who may operate the user device 150B (or in some examples operate the same user device as the first end user). It should be noted that other numbers of end users may use the same or different user devices 150 to collaboratively share project data as well. The second end user may similarly enter the DNS name into a browser of a user device 150. Entering the DNS name into the browser will transmit a request to access a page associated with the DNS name, such as a splash page of the containerized collaboration application 144. The request may be made according to a transfer protocol such as a hypertext transfer protocol (HTTP).

The DNS name of the PC endpoint 250 is resolved to a private IP address of the PC endpoint 250. The private IP address is then used to forward the request to access the containerized collaboration application 144 to the PC endpoint 250, which then transmits the request to the container 142 based on its pre-configuration to operate with the container 142. The containerized collaboration application 144 receives the request and transmits back the splash page, which may include the virtual workspace 146 or portions of it. It should be noted that the splash page may be a user authentication page in which the end user is required to authenticate according to IAM policies of the containerized collaboration application 144. After such authentication, portions or all of the virtual workspace 146 may be transmitted to the requesting user device 150 through the PC endpoint 250. It should be noted that the foregoing and network traffic within the private cloud 140 described below may be routed and allocated to appropriate hardware resources by the network load balancer 240 illustrated in FIG. 2. The foregoing describes an example of how user devices 150 may connect to the private cloud 140 to access the containerized collaboration application 144 and the virtual workspace 146 provided by the containerized collaboration application 144. Attention will now turn to an example of collaboratively sharing project data once the connection has been established.

At 402, the user device 150A may transmit a request using DNS address, valid DNS will route request to load balancer via the PC endpoint 250, to commit a first action on the virtual workspace 146. The first action may be to modify project data such as a file that is stored at the serverless filesystem 230. The first action may be to collaboratively share the project data in ways other than modify as well or instead. At 404, the PC endpoint 250 may forward the request to the containerized collaboration application 144. At 406, the containerized collaboration application 144 may determine that the file is stored at the serverless filesystem 230, such as via an internal memory that stores the location of project data along with identifiers of the project data—in this case, a file identifier such as a filename. At 408, the containerized collaboration application 144 may access the serverless filesystem 230 to modify the file (read the file and modify the file, or store a modified version of the file). At 410, the serverless filesystem 230 may store the modified file and transmit an indication of such modification at 412. At 414A and 414B, the containerized collaboration application 144 may transmit back to the user device 150A an indication of a status the modified file, such as by showing the modified file in the virtual workspace 146 or indicating that the file has been modified.

At 416, the user device 150B may transmit a request, via the PC endpoint 250, to commit a second action on the virtual workspace 146. The second action may be to insert new project data such as a calendar entry that is stored at the serverless database 220. The second action may be to collaboratively share the project data in ways other than to create new project data as well or instead. It should be noted that the modified file from the user device 150A may be provided to the user device 150B via the virtual workspace 146 at this point, assuming that the second action is requested after the first action.

At 418, the PC endpoint 250 may forward the request to the containerized collaboration application 144. At 420, the containerized collaboration application 144 may determine that calendar entries are stored at the serverless database 220, such as via the internal memory. At 422, the containerized collaboration application 144 may access the serverless database 220 to insert the new calendar entry such as via an SQL insert command. At 424, the serverless database 220 may insert the new calendar entry and transmit an indication of such insertion at 426. At 428A and 428B, the containerized collaboration application 144 may transmit back to the user device 150B an indication of a status the insertion, such as by showing the new calendar entry in the virtual workspace 146, which may be updated for all end users who access the containerized collaboration application 144.

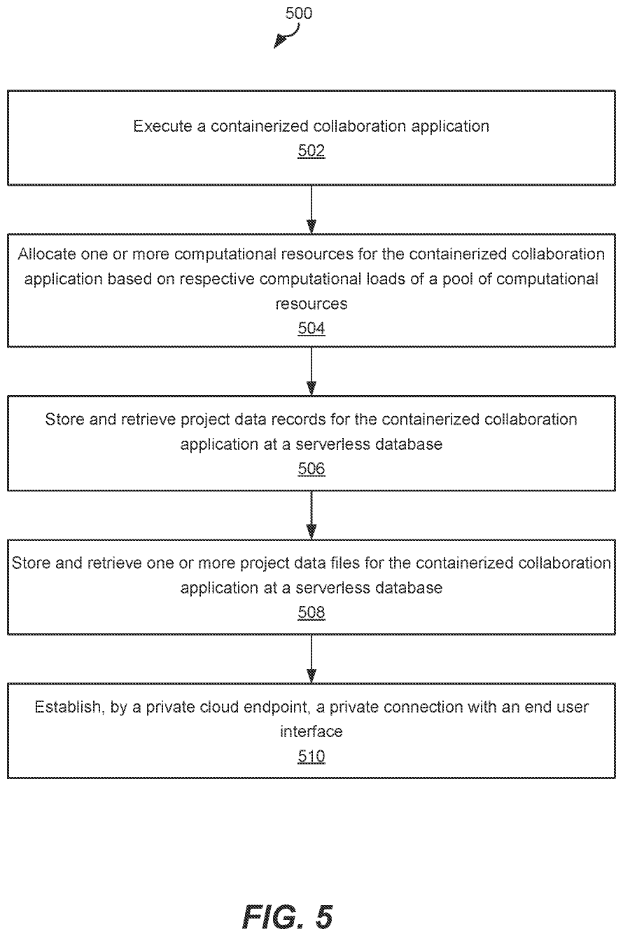

FIG. 5 illustrates an example of a method 500 of sharing project data using a containerized collaboration application 144. At 502, the method 500 may include executing a containerized collaboration application 144 within a container 142. To do so, the method 500 may include accessing, by a container platform interface 210, a containerized application definition 103 comprising an identifier of a container image 121 of the collaboration application 113, obtaining the container image 121 of the collaboration application 113 from a container platform 120 based on the identifier, and generating the container 142 for the container image 121. The container 142 may execute the collaboration application 113 within the container 142 (which is referred to as a containerized collaboration application 144). The container 142 is assigned an Internet Protocol (IP) address and is associated with a security group that controls network traffic to and from the container 142.

At 504, the method 500 may allocating, by a network load balancer 240, configured with the IP address assigned to the container that allocates one or more computational resources for executing the containerized collaboration application based on respective computational loads of a pool of computational resources. At 506, the method 500 may include storing and retrieving, by a serverless database that is enabled with the security group of the container 142, project data for the containerized collaboration application 144 executing within the container 142.

At 508, the method 500 may include storing and retrieving, by the serverless filesystem 230, one or more project data files for the containerized collaboration application 144. The serverless filesystem 230 may further receive an installation of the containerized collaboration application 144 and host a home directory used by the containerized collaboration application 144 executing within the container 142. The serverless filesystem 230 is also enabled with the security group of the container 142. At 510, the method 500 may include a establishing, by a private cloud (PC) endpoint 250, a private connection with an end user interface. The private connection provides secure network traffic between the PC endpoint 250 and the end user interface.

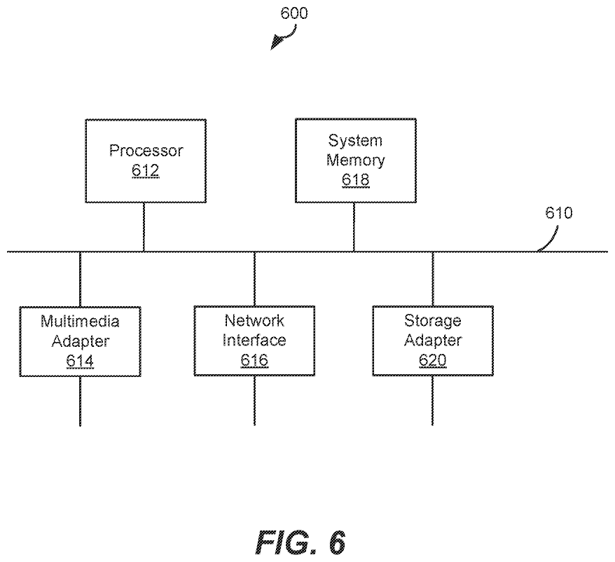

FIG. 6 illustrates an example of a computer system 600 that may be implemented by devices illustrated in FIGS. 1 and 2. The computer system 600 may be part of or include the system environment 100 to perform the functions and features described herein. For example, various ones of the devices of system environment 100 may be implemented based on some or all of the computer system 600.

The computer system 600 may include, among other things, an interconnect 610, a processor 612, a multimedia adapter 614, a network interface 616, a system memory 618, and a storage adapter 620.

The interconnect 610 may interconnect various subsystems, elements, and/or components of the computer system 600. As shown, the interconnect 610 may be an abstraction that may represent any one or more separate physical buses, point-to-point connections, or both, connected by appropriate bridges, adapters, or controllers. In some examples, the interconnect 610 may include a system bus, a peripheral component interconnect (PCI) bus or PCI-Express bus, a HyperTransport or industry standard architecture (ISA)) bus, a small computer system interface (SCPI) bus, a universal serial bus (USB), IIC (I2C) bus, or an Institute of Electrical and Electronics Engineers (IEEE) standard 1384 bus, or “firewire,” or other similar interconnection element.

In some examples, the interconnect 610 may allow data communication between the processor 612 and system memory 618, which may include read-only memory (ROM) or flash memory (neither shown), and random-access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 612 may control operations of the computer system 600. In some examples, the processor 612 may do so by executing instructions such as software or firmware stored in system memory 618 or other data via the storage adapter 620. In some examples, the processor 612 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 614 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 616 may provide the computer system 600 with an ability to communicate with a variety of remote devices over a network such as a communication network. The network interface 616 may include, for example, an Ethernet adapter, a Fibre Channel adapter, and/or other wired- or wireless-enabled adapter. The network interface 616 may provide a direct or indirect connection from one network element to another, and facilitate communication and between various network elements.

The storage adapter 620 may connect to a standard computer readable medium for storage and/or retrieval of information, such as a fixed disk drive (internal or external).

Other devices, components, elements, or subsystems (not illustrated) may be connected in a similar manner to the interconnect 610 or via a network such as a communication network. The devices and subsystems can be interconnected in different ways from that shown in FIG. 6. Instructions to implement various examples and implementations described herein may be stored in computer-readable storage media such as one or more of system memory 618 or other storage. Instructions to implement the present disclosure may also be received via one or more interfaces and stored in memory. The operating system provided on computer system 600 may be MS-DOS®, MS-WINDOWS®, OS/2®, OS X®, IOS®, ANDROID®, UNIX®, Linux®, or another operating system.

Throughout the disclosure, the terms “a” and “an” may be intended to denote at least one of a particular element. As used herein, the term “includes” means includes but not limited to, the term “including” means including but not limited to. The term “based on” means based at least in part on. In the Figures, the use of the letter “N” to denote plurality in reference symbols is not intended to refer to a particular number. For example, “150A-N” does not refer to a particular number of instances of 150, but rather “one or more.”

The serverless database and other datastores described herein may include, or interface to, for example, a MYSQL database, a POSTGRESS database, an Oracle™ relational database sold commercially by Oracle Corporation. Other databases, such as Informix™, DB2 or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may include cloud-based storage solutions. The database may store a plurality of types of data and/or files and associated data or file descriptions, administrative information, or any other data. The various databases may store predefined and/or customized data described herein.

The systems and processes are not limited to the specific embodiments described herein. In addition, components of each system and each process can be practiced independently and separate from other components and processes described herein. Each component and process can also be used in combination with other assembly packages and processes. The flow charts and descriptions thereof herein should not be understood to prescribe a fixed order of performing the method blocks described therein. Rather the method blocks may be performed in any order that is practicable including simultaneous performance of at least some method blocks. Furthermore, each of the methods may be performed by one or more of the system components illustrated in FIGS. 1 and 2.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. Example computer-readable media may be, but are not limited to, a flash memory drive, digital versatile disc (DVD), compact disc (CD), fixed (hard) drive, diskette, optical disk, magnetic tape, semiconductor memory such as read-only memory (ROM), and/or any transmitting/receiving medium such as the Internet or other communication network or link. By way of example and not limitation, computer-readable media comprise computer-readable storage media and communication media. Computer-readable storage media are tangible and non-transitory and store information such as computer-readable instructions, data structures, program modules, and other data. Communication media, in contrast, typically embody computer-readable instructions, data structures, program modules, or other data in a transitory modulated signal such as a carrier wave or other transport mechanism and include any information delivery media. Combinations of any of the above are also included in the scope of computer-readable media. The article of manufacture containing the computer code may be made and/or used by executing the code directly from one medium, by copying the code from one medium to another medium, or by transmitting the code over a network.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for serverless containerization of a collaboration application that provides a virtual workspace for end users, comprising:
one or more processors programmed to implement:
a container platform interface configured to
access a containerized application definition comprising a container identifier that identifies a container image of the collaboration application,
obtain the container image of the collaboration application from a container platform based on the container identifier,
generate a container for the container image, and
execute the collaboration application within the container based on the container image, wherein the container is assigned with an Internet Protocol (IP) address and is associated with a security group that controls network traffic to and from the container;
a network load balancer configured with the IP address assigned to the container, the network load balancer allocating one or more computational resources for executing the collaboration application based on respective computational loads of a pool of computational resources;
a serverless database that is enabled with the security group of the container, the serverless database storing one or more project data records for the collaboration application executing within the container;
a serverless filesystem configured to receive an installation of the collaboration application and to host a home directory used by the collaboration application executing within the container, wherein the serverless filesystem is also enabled with the security group of the container; and
a private cloud (PC) endpoint configured to establish a private connection with an end user interface, wherein the private connection provides secure network traffic between the PC endpoint the end user interface within a private network of the PC endpoint.

2. The system of claim 1, wherein the one or more processors are further programmed to:
receive, via the PC endpoint, a first action on a workspace being collaboratively shared, wherein the virtual workspace includes data that is stored at the serverless filesystem and/or the serverless database for the container;
update the data that is stored at the serverless filesystem and/or the serverless database for the container based on the first action; and
transmit, via the PC endpoint, the updated data via the virtual workspace to one or more other end user interfaces that are coupled to the PC endpoint.

3. The system of claim 1, wherein the one or more processors are further programmed to:
receive a request to change to a second version of the collaboration application, the request comprising a second identifier of a second container image of the second version;
obtain the second container image based on the second identifier; and
generate a second container based on the second container image.

4. The system of claim 3, wherein the second version is a next version of the collaboration application.

5. The system of claim 3, wherein the second version is a previous version of the collaboration application.

6. The system of claim 1, wherein the one or more processors are further programmed to:
receive a request to terminate the container responsive to a zero day vulnerability; and
terminate the container responsive to the request.

7. The system of claim 1, wherein the containerized application definition is generated via a typescript language.

8. The system of claim 1, the one or more processors are further programmed to:
access, from the containerized application definition, a security group definition that configures permitted or denied network traffic; and
control network traffic to or from the container based on the security group definition.

9. The system of claim 1, the one or more processors are further programmed to:
access, from the containerized application definition, a database requirement for the collaboration application, wherein the serverless database is generated based on the database requirement.

10. The system of claim 1, the one or more processors are further programmed to:
access, from the containerized application definition, an installation directory for the collaboration application; and
allocate the installation directory in the serverless filesystem based on the installation directory.

11. The system of claim 1, the one or more processors are further programmed to:
access, from the containerized application definition, an indication to configure a connection between the container and the end user interface; and
establish the PC endpoint responsive to the indication.

12. A method of serverless containerization of a collaboration application that provides a virtual workspace for end users, comprising:
by a container platform interface: accessing a containerized application definition comprising a container identifier that identifies a container image of the collaboration application, obtaining the container image of the collaboration application from a container platform based on the container identifier, generating a container for the container image, and executing the collaboration application within the container based on the container image, wherein the container is assigned with an Internet Protocol (IP) address and is associated with a security group that controls network traffic to and from the container;
allocating, by a network load balancer configured with the IP address assigned to the container, one or more computational resources for executing the collaboration application based on respective computational loads of a pool of computational resources;
storing, by a serverless database that is enabled with the security group of the container, one or more project data records for the collaboration application executing within the container;
by a serverless filesystem enabled with the security group of the container: receiving an installation of the collaboration application and hosting a home directory used by the collaboration application executing within the container; and
establishing, by a private cloud (PC) endpoint, a connection with an end user interface, wherein the private connection provides secure network traffic between the PC endpoint the end user interface within a private network of the PC endpoint.

13. The method of claim 12, further comprising:
receiving, via the PC endpoint, a first action on a workspace being collaboratively shared, wherein the virtual workspace includes data that is stored at the serverless filesystem and/or the serverless database for the container;
updating the data that is stored at the serverless filesystem and/or the serverless database for the container based on the first action; and
transmitting, via the PC endpoint, the updated data via the virtual workspace 146 to one or more other end user interfaces that are coupled to the PC endpoint.

14. The method of claim 12, further comprising:
receiving a request to change to a second version of the collaboration application, the request comprising a second identifier of a second container image of the second version;
obtaining the second container image based on the second identifier; and
generating a second container based on the second container image.

15. The method of claim 14, wherein the second version is a next version of the collaboration application.

16. The method of claim 14, wherein the second version is a previous version of the collaboration application.

17. The method of claim 12, further comprising:
receiving a request to terminate the container responsive to a zero day vulnerability; and
terminating the container responsive to the request.

18. The method of claim 12, wherein the containerized application definition is generated via a typescript language.

19. The method of claim 12, further comprising:
accessing, from the containerized application definition, a security group definition that configures permitted or denied network traffic; and
controlling network traffic to or from the container based on the security group definition.

20. A non-transitory computer readable storing instructions for serverless containerization of a collaboration application that provides a virtual workspace for end users, the instructions, when executed by one or more processors, program the one or more processors to implement:
a container platform interface configured to:
access a containerized application definition comprising a container identifier that identifies a container image of the collaboration application,
obtain the container image of the collaboration application from a container platform based on the container identifier,
generate a container for the container image, and
execute the collaboration application within the container based on the container image, wherein the container is assigned with an Internet Protocol (IP) address and is associated with a security group that controls network traffic to and from the container;
a network load balancer configured with the IP address assigned to the container, the network load balancer allocating one or more computational resources for executing the collaboration application based on respective computational loads of a pool of computational resources;
a serverless database that is enabled with the security group of the container, the serverless database storing one or more project data records for the collaboration application executing within the container;
a serverless filesystem configured to receive an installation of the collaboration application and to host a home directory used by the collaboration application executing within the container, wherein the serverless filesystem is also enabled with the security group of the container, and
a private cloud (PC) endpoint configured to establish a private connection with an end user interface, wherein the private connection provides secure network traffic between the PC endpoint the end user interface within a private network of the PC endpoint.
